(19) United States
(12) Patent Application Publication
(10) Pub. No.: US 2025/0112354 A1
(43) Pub. Date: Apr. 3, 2025

(54) Electronic Device Having Support Plate Antenna

(71) Applicant: Apple Inc., Cupertino, CA (US)

(72) Inventors: Seyed Mohammad Amjadi, Santa Clara, CA (US); Yiren Wang, Cupertino, CA (US); Sidharath Jain, Redwood City, CA (US); Victor C Lee, Santa Clara, CA (US); Mattia Pascolini, San Francisco, CA (US); Alden T Rush, San Diego, CA (US); Yuan Tao, Santa Clara, CA (US); Hao Xu, Cupertino, CA (US); Carlo Di Nallo, Belmont, CA (US)

(21) Appl. No.: 18/477,872

(22) Filed: Sep. 29, 2023

(51) Int. Cl. H01Q 1/22; H01Q 1/42; H01Q 13/10

(52) U.S. Cl. CPC H01Q 1/22; H01Q 1/42; H01Q 13/10

(57) ABSTRACT

An electronic device may be provided with peripheral conductive housing structures and a rear housing wall. The electronic device may have a display mounted to the peripheral conductive housing structures opposite the rear housing wall. The rear housing wall may have a dielectric cover layer and a conductive support plate that extends along the dielectric cover layer. The electronic device may have an antenna that radiates through the dielectric cover layer. The antenna may have a slot antenna resonating element that includes a first slot between the support plate and the peripheral structures and may include a second slot extending from the first slot into the support plate. A conductive interconnect may couple the support plate to the peripheral conductive housing structures at an end of the first slot. The antenna may be fed at a feed protrusion that extends into the second slot.

### FIELD

This relates generally to electronic devices, including electronic devices with wireless communications capabilities.

### BACKGROUND

Electronic devices such as portable computers and cellular telephones are often provided with wireless communications capabilities and displays. To satisfy consumer demand for small form factor wireless devices, manufacturers are continually striving to implement wireless communications circuitry such as antenna components using compact structures. At the same time, there is a desire for wireless devices to cover a growing number of communications bands. In addition, to optimize user experience, it is often desirable for the viewing area of a display in an electronic device to be as large as possible.

Because antennas have the potential to interfere with each other and with components in a wireless device such as displays, care must be taken when incorporating antennas into an electronic device. Moreover, care must be taken to ensure that the antennas and wireless circuitry in a device are able to exhibit satisfactory performance over a range of operating frequencies and with satisfactory efficiency bandwidth while still allowing the device to exhibit a compact form factor.

### SUMMARY

An electronic device may be provided with wireless circuitry and a housing. The housing may include peripheral conductive housing structures and a rear housing wall mounted to the peripheral conductive housing structures. The electronic device may have a display mounted to the peripheral conductive housing structures opposite the rear housing wall. The rear housing wall may have a dielectric cover layer and a conductive support plate that extends along the dielectric cover layer.

The electronic device may have an antenna that radiates through the dielectric cover layer. The antenna may have a slot antenna resonating element. The slot antenna resonating element may include a first slot between the conductive support plate and the peripheral conductive housing structures. The slot antenna resonating element may include a second slot extending from the first slot into the conductive support plate. A conductive interconnect may couple the conductive support plate to the peripheral conductive housing structures at an end of the first slot. The antenna may be fed at a feed protrusion that extends into the second slot. A flexible printed circuit may be coupled to the feed protrusion by a conductive spring. The conductive support plate may include one or more electromagnetic isolation slots that isolate the antenna from other device components. The antenna may exhibit optimal efficiency and bandwidth for radiating through the rear of the device.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a cross-sectional side view of an electronic device having housing structures that may be used in forming antenna structures in accordance with some embodiments.

FIG. 5 is a rear interior view of the upper end of an illustrative electronic device having an antenna formed from a slot in a conductive support plate in accordance with some embodiments.

FIG. 6 is a cross-sectional side view showing how an illustrative antenna formed from a slot in a conductive support plate may be fed in accordance with some embodiments.

FIG. 7 is a rear interior view of an illustrative antenna formed from a slot in a conducive support plate that is fed by a protrusion of the support plate having a bend in accordance with some embodiments.

FIG. 8 is a rear interior view of an illustrative antenna formed from a slot in a conducive support plate that is fed by a protrusion of the support plate having multiple bends in accordance with some embodiments.

FIG. 9 is a rear interior view of an illustrative antenna formed from an expanded slot in a conducive support plate in accordance with some embodiments.

### DETAILED DESCRIPTION

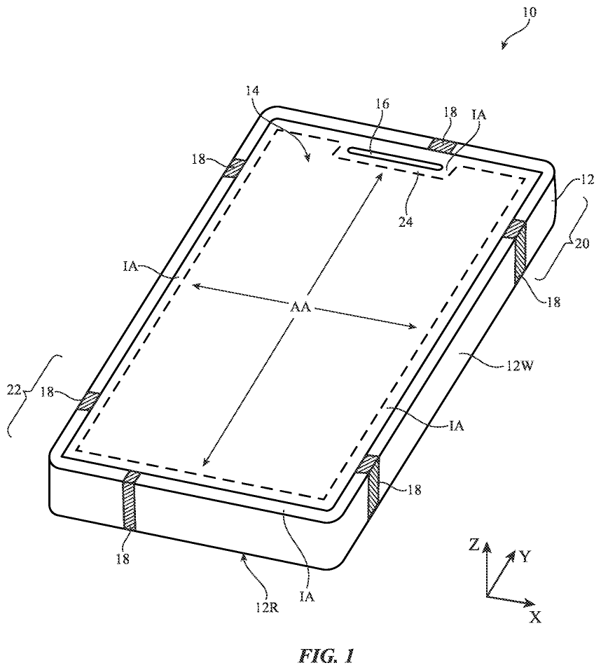

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device (e.g., virtual, augmented, or mixed reality glasses or goggles), or another wearable or miniature device, a handheld device such as a cellular telephone, a media player, or another small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. Alternatively, notch 24 may be defined on all sides by (e.g., may be surrounded and enclosed by) active area AA (e.g., notch 24 may form an inactive island in the pixel circuitry of display 14). One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is illustrative and non-limiting.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is illustrative and non-limiting. If desired, housing 12 may have other shapes (e.g., a square shape, cylindrical shape, spherical shape, combinations of these and/or different shapes, etc.).

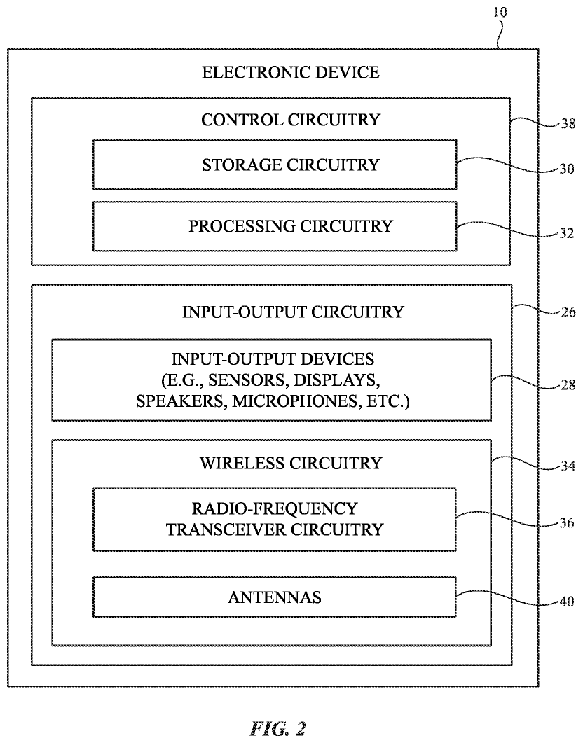

A schematic diagram of illustrative components that may be used in device 10 is shown in FIG. 2. As shown in FIG. 2, device 10 may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external equipment, control circuitry 38 may be used in implementing communications protocols. Communications protocols that may be implemented using control circuitry 38 include internet protocols, wireless local area network protocols (e.g., IEEE 802.11 protocols-sometimes referred to as WiFi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals. While control circuitry 38 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband processor circuitry or other control components that form a part of wireless circuitry 34.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 34 may include radio-frequency transceiver circuitry 36 for handling transmission and/or reception of radio-frequency signals within corresponding frequency bands at radio frequencies (sometimes referred to herein as communications bands or simply as “bands”). The frequency bands handled by radio-frequency transceiver circuitry 36 may include wireless local area network (WLAN) frequency bands (e.g., Wi-Fi® (IEEE 802.11) or other WLAN communications bands) such as a 2.4 GHZ WLAN band (e.g., from 2400 to 2480 MHZ), a 5 GHZ WLAN band (e.g., from 5180 to 5825 MHZ), a Wi-Fi® 6E band (e.g., from 5925-7125 MHz), and/or other Wi-Fi® bands (e.g., from 1875-5160 MHZ), wireless personal area network (WPAN) frequency bands such as the 2.4 GHZ Bluetooth® band or other WPAN communications bands, cellular telephone communications bands such as a cellular low band (LB) (e.g., 600 to 960 MHZ), a cellular low-midband (LMB) (e.g., 1400 to 1550 MHZ), a cellular midband (MB) (e.g., from 1700 to 2200 MHZ), a cellular high band (HB) (e.g., from 2300 to 2700 MHZ), a cellular ultra-high band (UHB) (e.g., from 3300 to 5000 MHz, or other cellular communications bands between about 600 MHZ and about 5000 MHZ), 3G bands, 4G LTE bands, 3GPP 5G New Radio Frequency Range 1 (FR1) bands below 10 GHZ, 3GPP 5G New Radio (NR) Frequency Range 2 (FR2) bands between 20 and 60 GHZ, other centimeter or millimeter wave frequency bands between 10-300 GHZ, near-field communications frequency bands (e.g., at 13.56 MHZ), satellite navigation frequency bands such as the Global Positioning System (GPS) L1 band (e.g., at 1575 MHZ), L2 band (e.g., at 1228 MHZ), L3 band (e.g., at 1381 MHz), L4 band (e.g., at 1380 MHZ), and/or L5 band (e.g., at 1176 MHZ), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHZ and/or a second UWB communications band at 8.0 GHZ), communications bands under the family of 3GPP wireless communications standards, communications bands under the IEEE 802.XX family of standards, satellite communications bands such as an L-band, S-band (e.g., from 2-4 GHZ), C-band (e.g., from 4-8 GHZ), X-band, Ku-band (e.g., from 12-18 GHZ), Ka-band (e.g., from 26-40 GHZ), etc., industrial, scientific, and medical (ISM) bands such as an ISM band between around 900 MHZ and 950 MHz or other ISM bands below or above 1 GHZ, one or more unlicensed bands, one or more bands reserved for emergency and/or public services, and/or any other desired frequency bands of interest. Wireless circuitry 34 may also be used to perform spatial ranging operations if desired.

The UWB communications handled by radio-frequency transceiver circuitry 36 may be based on an impulse radio signaling scheme that uses band-limited data pulses. Radio-frequency signals in the UWB frequency band may have any desired bandwidths such as bandwidths between 499 MHz and 1331 MHz, bandwidths greater than 500 MHZ, etc. The presence of lower frequencies in the baseband may sometimes allow ultra-wideband signals to penetrate through objects such as walls. In an IEEE 802.15.4 system, for example, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals).

Radio-frequency transceiver circuitry 36 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). Radio-frequency transceiver circuitry 36 may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

In general, radio-frequency transceiver circuitry 36 may cover (handle) any desired frequency bands of interest. As shown in FIG. 2, wireless circuitry 34 may include antennas 40. Radio-frequency transceiver circuitry 36 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. If desired, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals within a signal beam formed in a desired beam pointing direction that may be steered/adjusted over time). Different types of antennas may be used for different bands and combinations of bands.

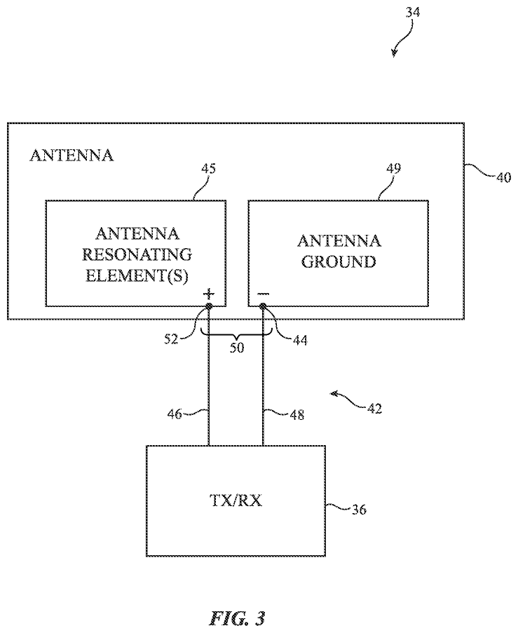

FIG. 3 is a schematic diagram showing how a given antenna 40 may be fed by radio-frequency transceiver circuitry 36. As shown in FIG. 3, antenna 40 may have a corresponding antenna feed 50. Antenna 40 may include one or more antenna resonating (radiating) elements 45 and an antenna ground 49. Antenna resonating element(s) 45 may include one or more radiating arms, slots, waveguides, dielectric resonators, patches, parasitic elements, indirect feed elements, and/or any other desired antenna radiators. Antenna feed 50 may include a positive antenna feed terminal 52 coupled to at least one antenna resonating element 45 and a ground antenna feed terminal 44 coupled to antenna ground 49. If desired, one or more conductive paths (sometimes referred to herein as ground paths, short paths, or return paths) may couple antenna resonating element(s) 45 to antenna ground 49.

Radio-frequency transceiver (TX/RX) circuitry 36 may be coupled to antenna feed 50 using a radio-frequency transmission line path 42 (sometimes referred to herein as transmission line path 42). Transmission line path 42 may include a signal conductor such as signal conductor 46 (e.g., a positive signal conductor). Transmission line path 42 may include a ground conductor such as ground conductor 48. Ground conductor 48 may be coupled to ground antenna feed terminal 44 of antenna feed 50. Signal conductor 46 may be coupled to positive antenna feed terminal 52 of antenna feed 50.

Transmission line path 42 may include one or more radio-frequency transmission lines. The radio-frequency transmission line(s) in transmission line path 42 may include stripline transmission lines (sometimes referred to herein simply as striplines), coaxial cables, coaxial probes realized by metalized vias, microstrip transmission lines, edge-coupled microstrip transmission lines, edge-coupled stripline transmission lines, waveguide structures, combinations of these, etc. Multiple types of radio-frequency transmission line may be used to form transmission line path 42. Filter circuitry, switching circuitry, impedance matching circuitry, phase shifter circuitry, amplifier circuitry, and/or other circuitry may be interposed on transmission line path 42, if desired. One or more antenna tuning components for adjusting the frequency response of antenna 40 in one or more bands may be interposed on transmission line path 42 and/or may be integrated within antenna 40 (e.g., coupled between the antenna ground and the antenna resonating element of antenna 40, coupled between different portions of the antenna resonating element of antenna 40, etc.).

If desired, one or more of the radio-frequency transmission lines in transmission line path 42 may be integrated into ceramic substrates, rigid printed circuit boards, and/or flexible printed circuits. In one suitable arrangement, the radio-frequency transmission lines may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All the multiple layers of the laminated structures may be batch laminated together (e.g., in a single pressing process) without adhesive (e.g., as opposed to performing multiple pressing processes to laminate multiple layers together with adhesive).

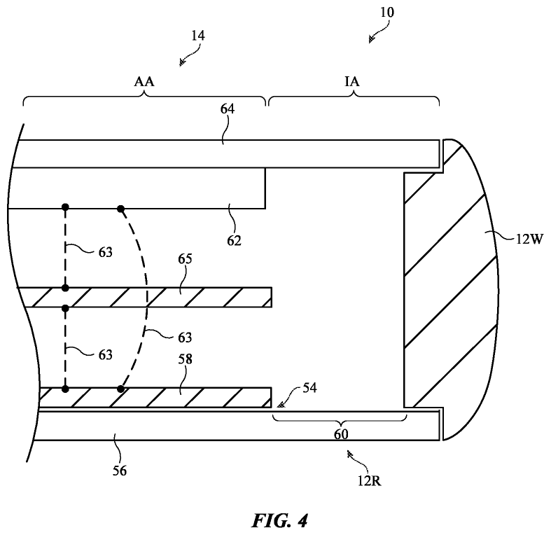

If desired, conductive electronic device structures such as conductive portions of housing 12 (FIG. 1) may be used to form at least part of one or more of the antennas 40 in device 10. FIG. 4 is a cross-sectional side view of device 10, showing illustrative conductive electronic device structures that may be used in forming one or more of the antennas 40 in device 10.

As shown in FIG. 4, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 4 (e.g., a given sidewall that runs along an edge of device 10 and that extends across the width or length of device 10).

Display 14 may have a display module such as display module 62 (sometimes referred to as a display panel). Display module 62 may include pixel circuitry, touch sensor circuitry, force sensor circuitry, and/or any other desired circuitry for forming active area AA of display 14. Display 14 may include a dielectric cover layer such as display cover layer 64 that overlaps display module 62. Display cover layer 64 may include plastic, glass, sapphire, ceramic, and/or any other desired dielectric materials. Display module 62 may emit image light and may receive sensor input (e.g., touch and/or force sensor input) through display cover layer 64. Display cover layer 64 and display 14 may be mounted to peripheral conductive housing structures 12W. The lateral area of display 14 that does not overlap display module 62 may form inactive area IA of display 14.

As shown in FIG. 4, rear housing wall 12R may be mounted to peripheral conductive housing structures 12W (e.g., opposite display 14). Rear housing wall 12R may include a dielectric cover layer such as dielectric cover layer 56. Dielectric cover layer 56 may include glass, plastic, sapphire, ceramic, one or more dielectric coatings, or other dielectric materials. If desired, conductive material may be layered onto some of the interior lateral surface of dielectric cover layer 56. Dielectric cover layer 56 may extend across an entirety of the width of device 10 and/or an entirety of the length of device 10. If desired, dielectric cover layer 56 may be provided with pigmentation and/or an opaque masking layer (e.g., an ink layer) that helps to hide the interior of device 10 from view.

The housing for device 10 may also include one or more conductive support plates interposed between display 14 and rear housing wall 12R. For example, the housing for device 10 may include a first conductive support plate such as conductive support plate 58 and/or may include a second support plate such as conductive support plate 65. Conductive support plate 58 is vertically interposed between dielectric cover layer 56 and display module 62. Conductive support plate 65 is vertically interposed between conductive support plate 58 and display module 62. Conductive support plate 58 is sometimes also referred to herein as conductive lower chassis 58, lower chassis 58, conductive lower plate 58, lower plate 58, lower interior conductive housing wall 58, conductive layer 58, lower conductive layer 58, or lower conductive support plate 58. Conductive support plate 65 is sometimes also referred to herein as conductive mid-chassis 65, mid-chassis 65, conductive mid-plate 65, mid-plate 65, upper interior conductive housing wall 65, conductive layer 65, upper conductive layer 65, or upper conductive support plate 65.

Conductive support plate 58 may be layered onto dielectric cover layer 56 without adhesive that adheres conductive support plate 58 to dielectric cover layer 56 or may be separated from dielectric cover layer 56 by a non-zero distance (e.g., an air gap). This may, for example, allow dielectric cover layer 56 and/or rear housing wall 12R to be easily removed from device 10 (e.g., to repair and/or replace components within the interior of device 10). Alternatively, conductive support plate 58 may be adhered to dielectric cover layer 56 (e.g., may form a part of rear housing wall 12R). Mid-chassis 65 may be located at a first distance from display 14 whereas conductive support plate 58 is located at a second distance that is greater than the first distance from display 14. If desired, mid-chassis 65 may be omitted from device 10.

Mid-chassis 65 and/or conductive support plate 58 may extend across an entirety of the width of device 10 (e.g., between the left and right edges of device 10 as shown in FIG. 1). Mid-chassis 65 may be formed from an integral portion of peripheral conductive housing structures 12W that extends across the width of device 10 or may include a separate housing structures attached, coupled, or affixed (e.g., welded) to peripheral conductive housing structures 12W. Conductive support plate 58 may, if desired, be formed from a separate conductor than peripheral conductive housing structures 12W (e.g., conductive support plate 58 and peripheral conductive housing structures 12W are not formed from an integral piece of metal) to help facilitate removal of rear housing wall 12R, for example. One or more components may be supported by mid-chassis 65 and/or conductive support plate 58 (e.g., logic boards such as a main logic board, a battery, etc.). Mid-chassis 65 and/or conductive support plate 58 may contribute to the mechanical strength of device 10 (e.g., to prevent external twisting or bending forces from damaging device 10). Mid-chassis 65 and/or conductive support plate 58 may be formed from metal (e.g., stainless steel, aluminum, titanium, etc.).

Conductive support plate 58, mid-chassis 65, and/or display module 62 may have an edge 54 that is separated from peripheral conductive housing structures 12W by dielectric-filled slot 60 (sometimes referred to herein as opening 60, gap 60, or aperture 60). Slot 60 may be filled with air, plastic, ceramic, or other dielectric materials. Conductive housing structures such as conductive support plate 58, mid-chassis 65, conductive portions of display module 62, and/or peripheral conductive housing structures 12W (e.g., the portion of peripheral conductive housing structures 12W opposite conductive support plate 58, mid-chassis 65, and display module 62 at slot 60) may be used to form antenna structures for one or more of the antennas 40 in device 10.

For example, peripheral conductive housing structures 12W may form an antenna resonating element arm (e.g., an inverted-F antenna resonating element arm) in the antenna resonating element 45 (FIG. 3) of an antenna 40 in device 10. Mid-chassis 65, conductive support plate 58, and/or display module 62 may be used to form the antenna ground 49 (FIG. 3) for one or more of the antennas 40 in device 10 and/or to form one or more edges of slot antenna resonating elements for the antennas in device 10. One or more conductive interconnect structures 63 may electrically couple mid-chassis 65 to conductive support plate 58, one or more conductive interconnect structures 63 may electrically couple mid-chassis 65 to conductive structures in display module 62 (sometimes referred to herein as conductive display structures), and/or one or more conductive interconnect structures 63 may electrically couple conductive structures in display module 62 to conductive support plate 58 so that each of these elements form part of the antenna ground. The conductive structures in display module 62 may include a conductive frame, bracket, or support plate for display module 62, shielding layers in display module 62, ground traces in display module 62, pixel circuitry, etc.

Conductive interconnect structures 63 may serve to ground mid-chassis 65 to conductive support plate 58 and/or display module 62 (e.g., to ground conductive support plate 58 to the conductive display structures through mid-chassis 65) or may ground display module 62 directly to conductive support plate 58. Put differently, conductive interconnect structures 63 may hold the conductive structures in display module 62, mid-chassis 65, and/or conductive support plate 58 to a common ground or reference potential (e.g., as a system ground for device 10 that is used to form part of antenna ground 49 of FIG. 3). Conductive interconnect structures 63 may therefore sometimes be referred to herein as grounding structures 63, grounding interconnect structures 63, or vertical grounding structures 63. Conductive interconnect structures 63 may include conductive traces, conductive pins, conductive springs (e.g., y-springs or spring fingers), conductive prongs (e.g., conductive blades that mate with conductive spring fingers such as y-springs), conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to mid-chassis 65 and/or conductive support plate 58, and/or any other desired conductive interconnect structures.

In practice, it may be desirable for an antenna in device 10 to radiate through rear housing wall 12R of device 10. However, if care is not taken, the presence of conductive support plate 58 can block or undesirably limit the performance of antennas in conveying radio-frequency signals through rear housing wall 12R. To mitigate these issues, conductive support plate 58 can itself be used to form an antenna 40 that radiates through rear housing wall 12R. For example, conductive support plate 58 may include a slot that forms some or all of a slot antenna resonating element for an antenna 40 (e.g., a slot antenna) that radiates through rear housing wall 12R.

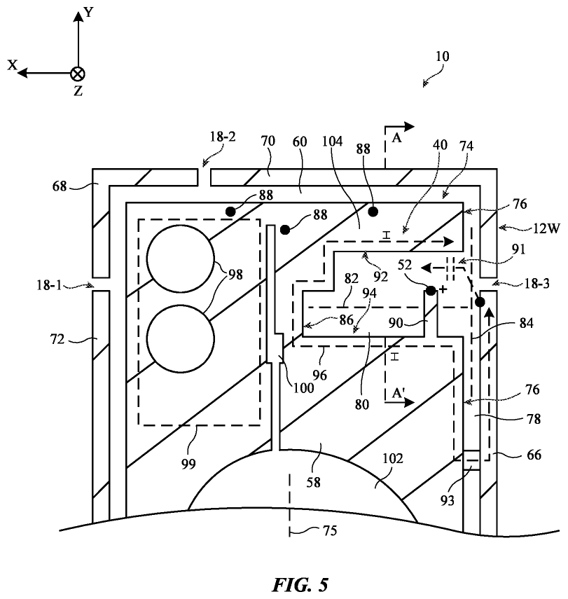

FIG. 5 is a rear interior view showing one example of how device 10 may include a slot antenna formed from a radiating slot in conductive support plate 58 at the upper end of device 10 (e.g., upper end 20 of FIG. 1). In the example of FIG. 5, dielectric cover layer 56 of rear housing wall 12R, mid-chassis 65, display 14, and the internal components of device 10 have been omitted for the sake of clarity.

As shown in FIG. 5, peripheral conductive housing structures 12W may include a first conductive sidewall at the left edge of device 10 (when device 10 is viewed from behind), a second conductive sidewall at the top edge of device 10, a third conductive sidewall at the right edge of device 10 (when device 10 is viewed from behind), and a fourth conductive sidewall at the bottom edge of device 10 (not shown in FIG. 5). Peripheral conductive housing structures 12W may be segmented (divided) by dielectric-filled gaps 18 such as a first gap 18-1, a second gap 18-2, and a third gap 18-3. Gaps 18-1, 18-2, and 18-3 may be filled with plastic, ceramic, sapphire, glass, epoxy, or other dielectric materials. The dielectric material in the gaps may lie flush with peripheral conductive housing structures 12W at the exterior surface of device 10 if desired.

Gap 18-1 may divide the first conductive sidewall to separate segment 72 of peripheral conductive housing structures 12W from segment 68 of peripheral conductive housing structures 12W. Gap 18-2 may divide the second conductive sidewall to separate segment 68 from segment 70 of peripheral conductive housing structures 12W. Gap 18-3 may divide the third conductive sidewall to separate segment 70 from segment 66 of peripheral conductive housing structures 12W. In this example, segment 68 forms the upper-left corner of device 10 when viewed from behind (e.g., segment 68 may have a bend at the corner) and is formed from the first and second conductive sidewalls of peripheral conductive housing structures 12W. Similarly, segment 70 forms the upper-right corner of device 10 when viewed from behind (e.g., segment 70 may have a bend at the corner) and is formed from the second and third conductive sidewalls of peripheral conductive housing structures 12W.

Conductive support plate 58 may extend across the length and width of device 10 (e.g., within the X-Y plane). Conductive support plate 58 may have an upper edge 74 that is separated from segments 68 and 70 of peripheral conductive housing structures 12W by slot 60. Edge 74 may extend across the width of device 10 (e.g., across substantially all of the width of device 10 and substantially parallel to the X-axis). Conductive support plate 58 may have a right edge 76 that is separated from segments 70 and 78 of peripheral conductive housing structures 12W by slot 60. Edge 76 may, for example, extend substantially perpendicular to edge 74. Edge 76 may extend across the length of device 10 (e.g., across substantially all of the length of device 10 and substantially parallel to the Y-axis). Edges 74 and 76 may, for example, form edge 54 of FIG. 4. Device 10 may have a longitudinal axis 75 that bisects the width of device 10 and that runs parallel to the length of device 10 (e.g., parallel to the Y-axis).

Slot 60 may have an elongated shape that extends from at least gap 18-1 or gap 18-2 to gap 18-3 between conductive support plate 58 and peripheral conductive housing structures 12W. If desired, slot 60 may extend around the entire periphery of conductive support plate 58. Slot 60 may have an elongated portion such as slot portion 78 that extends below gap 18-3 between edge 76 of conductive support plate 58 and segments 70 and 66 of peripheral conductive housing structures 12W.

Slot portion 78 may have a longitudinal axis 84 (e.g., extending parallel to longitudinal axis 75 of device 10). Slot portion 78 may have a closed end defined by conductive interconnect structure 93. Conductive interconnect structure 93 may couple edge 76 of conductive support plate 58 to segment 66 (and optionally conductive display structures) across the slot 60 between conductive support plate 58. Conductive interconnect structure 93 may include a conductive spring, a conductive screw, and/or a conductive snap, as examples. Slot portion 78 is sometimes also referred to herein simply as slot 78.

Device 10 may include an optical component such as camera 99 overlapping conductive support plate 58. Camera 99 may be mounted to conductive support plate 58 or to another substrate in device 10 such as a logic board or flexible printed circuit in device 10 (not shown). Camera 99 may, for example, form a rear-facing camera of device 10. Conductive support plate 58 may include one or more openings (holes) such as camera openings 98. Camera 99 may include one or more image sensors that protrude through camera openings 98 and that capture image sensor data (e.g., images) through camera openings 98. Camera 99 is sometimes also referred to herein as camera module 99. Conductive support plate 58 may include three, four, or more than four camera openings 98 if desired.

Conductive support plate 58 may also include an opening such as coil opening 102. Coil opening 102 may overlap an inductive coil in device 10 (not shown). The inductive coil may receive wireless power through the rear housing wall of device 10 and/or may convey wireless data (e.g., via near-field communications (NFC)) through the rear housing wall of device 10. Coil opening 102 may, for example, have a diameter that extends across more than half the width of device 10 to accommodate a relatively large coil for maximizing wireless charging and/or wireless data transfer rates. Camera openings 98 may be much smaller than coil opening 102 (e.g., having diameters less than half the width of device 10).

Device 10 may include an antenna 40 integrated into conductive support plate 58 for conveying radio-frequency signals through the rear housing wall of device 10. Antenna 40 may have a slot antenna resonating element (e.g., a radiating slot) formed from a slot in conductive support plate 58 such as slot 80. Slot 80 may protrude into the main body of conductive support plate 58 from slot portion 78 (slot 60). For example, as shown in FIG. 5, slot 80 in conductive support plate 58 may extend along a longitudinal axis 82 from slot portion 78 towards the center of device 10 (e.g., longitudinal axis 75) and camera openings 98. Slot 80 may have a closed end formed from an edge 86 of conductive support plate 58 opposite slot portion 78 and may have an open end defined by slot portion 78 (e.g., slot 80 may extend along longitudinal axis 82 from slot portion 78 to edge 86). Longitudinal axis 82 may, for example, be oriented perpendicular to slot portion 78.

Slot 80 may have edges 92 and 94 formed from respective edges of conductive support plate 58. Edges 92 and 94 may extend from edge 76 of conductive support plate 58 to edge 86. Slot 80 may have a length measured along the direction of longitudinal axis 82 and may have an orthogonal width measured between edges 92 and 94. The width may be less than the length. The length may be less than or equal to half the width of conductive support plate 58 and/or device 10.

Conductive support plate 58 may include a protruding portion (region) such as segment 104 that is laterally interposed between slot 80 and the portion of slot 60 between conductive support plate 58 and segment 70 of peripheral conductive housing structures 12W. The edges of segment 104 of conductive support plate 58 may be defined by edge 92 of slot 80, edge 76, and edge 74 of conductive support plate 58. Segment 104 may extend parallel to longitudinal axis 82 of slot 80.

If desired, slot portion 78 may protrude laterally downward beyond edge 94 of slot 80 (e.g., conductive interconnect structure 93 may be laterally offset from edge 94 of slot 80 by a non-zero distance). Alternatively, conductive interconnect structure 93 may couple conductive support plate 58 to segment 66 of peripheral conductive housing structures 12W at edge 94 (e.g., conductive interconnect structure 93 may be laterally aligned with edge 94).

Slot 80 may form some or all of a slot antenna resonating element for antenna 40 (e.g., antenna resonating element 45 of FIG. 3). Antenna 40 may be fed by a positive antenna feed terminal 52 coupled to an edge of the slot 80 in conductive support plate 58 (e.g., along edge 94). If desired, conductive support plate 58 may be fed at a protrusion or extension of the conductive support plate such as feed protrusion 90. Feed protrusion 90 may be formed from an integral piece of conductive support plate 58 that extends or protrudes into slot 80 (e.g., conductive support plate 58 and feed protrusion 90 may be formed from a single integral piece of sheet metal having openings such as camera openings 98, coil opening 102, and slot 80 stamped, etched, or cut therein). Positive antenna feed terminal 52 may be coupled to an end of feed protrusion 52 within slot 80. Feed protrusion 90 may extend perpendicular to longitudinal axis 82, parallel to longitudinal axis 84, or at other angles.

During signal transmission, antenna currents I are passed (fed) onto feed protrusion 90 by the radio-frequency transmission line for antenna 40 (not shown in FIG. 5 for the sake of clarity). The antenna currents flow around the perimeter of slot 80. If desired, the antenna currents may flow along a current path 96 from edge 76 of segment 104, along edge 92 of slot 80, along edge 86 of slot 80, along edge 94 of slot 80, along edge 76 of conductive support plate 58, across slot portion 78 through conductive interconnect structure 93, and along segment 66 of peripheral conductive housing structures 12W to gap 18-3.

The length of current path 96 (e.g., the perimeter and shape of slot 80, slot portion 78 from edge 94 to conductive interconnect structure 93, and segment 66 from conductive interconnect structure 93 to gap 18-3) may be selected to configure antenna 40 to resonate in one or more corresponding frequency bands. This resonance causes the antenna current I along current path 96 to radiate corresponding radio-frequency signals through the rear housing wall of device 10. In other words, slot 80 and the segment of slot portion 78 protruding below edge 94 to conductive interconnect structure 93 each form a respective portion or segment of a slot antenna resonating element for antenna 40 (e.g., where the perimeter and edges of the slot antenna resonating element are defined by edges 92, 86, and 94 of slot 80, edge 76 of conductive support plate 58, conductive interconnect structure 93, and segment 66 of peripheral conductive housing structures 12W). While referred to herein as slot 80 and slot portion 78, slot 80 and slot portion 78 are sometimes also referred to herein as respective portions, slot portions, segments, or arms of the same slot (e.g., the slot antenna resonating element of antenna 40).

Conversely, during signal reception, radio-frequency signals may be incident upon antenna 40 through the rear housing wall of device 10. The radio-frequency signals may produce antenna currents I along current path 96. The antenna currents may flow up feed protrusion 90 to positive antenna feed terminal 52, through which the currents are received by the transmission line for antenna 40.

By integrating antenna 40 into a plane as close to the rear face of device 10 as possible in this way (e.g., within conductive support plate 58 of rear housing wall 12R), antenna 40 may exhibit maximal antenna efficiency, maximal bandwidth, and as uniform a radiation pattern across the hemisphere behind device 10 as possible, while also maximizing isolation between the antenna and potential sources of signal interference in device 10. Further, the dielectric constant and/or thickness of dielectric cover layer 56 of rear housing wall 12R (FIG. 4) may be selected to configure dielectric cover layer 56 to form a smooth impedance transition between antenna 40 and free space (e.g., a quarter wave impedance transformer), thereby further optimizing antenna efficiency).

If desired, to further enhance the isolation of antenna 40, conductive support plate 58 may include an electromagnetic isolation slot such as slot 100. Slot 100 may extend upwards (e.g., along or parallel to longitudinal axis 75) from coil slot 102 towards slot 60 between camera 99 (camera openings 98) and slot 80 (e.g., slot 100 may be laterally interposed between camera openings 98 or camera 99 and slot 80). Slot 100 may serve to electromagnetically isolate slot 80 from potential electromagnetic interference produced by the concurrent operation of camera 99 and/or may help to prevent radio-frequency currents from being produced on camera openings 98 by antenna 40.

If desired, to further enhance the isolation of antenna 40 relative to other antennas in device 10 (e.g., antennas having resonating element arms formed from segments 68 and 70) and/or the display of device 10, conductive interconnect structures 88 may be used to couple (ground or short) conductive support plate 58 to display module 62 (FIG. 4) at one or more locations. As examples, conductive interconnect structures 88 may be coupled to conductive support plate 58 at or adjacent to camera 99, between slot 100 and slot 80, and/or on segment 104 of conductive support plate 58 (e.g., slot 100 may be laterally interposed between two or more conductive interconnect structures 88). Conductive interconnect structures 88 may include conductive springs, conductive pins, conductive fingers, and/or other conductive interconnect structures, as examples.

If desired, the antenna 40 may include one or more tuning components such as tuning component 91 (e.g., a capacitor) coupled between segment 66 (e.g., at or adjacent gap 18-3) and ground (e.g., any of the grounded structures in device 10). This may, for example, load the impedance of segment 66 to help tweak the frequency and/or resonant response of segment 66 and/or antenna 40 to fine tune the performance, efficiency, and/or bandwidth of antenna 40. Tuning component 91 may be fixed (e.g., may include a fixed capacitance and/or inductance) or may be switchable (e.g., may include one or more switched capacitors and/or switched inductors).

When configured in this way, the slot antenna resonating element of antenna 40 is a substantially L-shaped slot defined by conductive support plate 58 and segment 66 (e.g., at or adjacent gap 18-3) and having a first slot segment or arm formed from slot 80 and a second (orthogonal) slot segment or arm formed from slot portion 80, extending from the end of slot 80. The example of FIG. 5 is illustrative and non-limiting. In general, slot 80 and slot portion 78 may have other shapes (e.g., having any desired number of straight and/or curved edges, having any desired number of straight and/or curved segments, etc.).

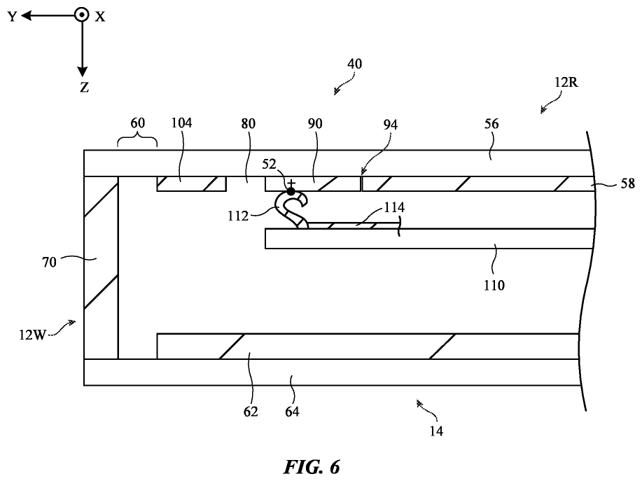

FIG. 6 is a cross-sectional side view showing how antenna 40 may be fed by feed protrusion 90 within slot 80 (e.g., as taken in the direction of line AA′ of FIG. 5). Mid-chassis 65 (FIG. 4) and other device components have been omitted from FIG. 6 for the sake of clarity.

As shown in FIG. 6, conductive support plate 58 may extend along dielectric cover layer 56 of rear housing wall 12R. Segment 104 of conductive support plate 58 may be laterally separated from segment 70 of peripheral conductive housing structures 12W by slot 60. Slot 80 may laterally separate segment 104 from edge 94 of conductive support plate 58. Feed protrusion 90 may be formed from an integral portion of conductive support plate 58 that laterally extends into slot 80 from edge 94.

A printed circuit 110 may overlap conductive support plate 58 and may laterally extend along conductive support plate 58. Printed circuit 110 may be a flexible printed circuit or may, if desired, be a rigid printed circuit board (e.g., a main logic board or another logic board in device 10). Printed circuit 110 may include conductive traces 114 that form part of the radio-frequency transmission line path 42 that feeds antenna 40 (e.g., part of signal conductor 46 of FIG. 3).

A conductive interconnect structure 112 may couple conductive traces 114 to feed protrusion 90 within slot 80 at positive antenna feed terminal 52. Conductive interconnect structure 112 may include a conductive blade (e.g., soldered or mounted to conductive traces 114) that is inserted into a conductive y-spring that is soldered onto feed protrusion 90, as one example. Conductive traces 114 may transmit antenna currents into feed protrusion 90 via positive antenna feed terminal 52 and conductive interconnect structure 112. Feed protrusion 90 may also convey antenna currents from edge 94 of conductive support plate 58 onto conductive traces 114 through positive antenna feed terminal 52 and conductive interconnect structure 112. The conductive interconnect structures described herein are sometimes also referred to herein simply as conductive interconnects. Alternatively, antenna 40 may be fed using a coaxial cable, a feed probe, and/or any other desired transmission line structures.

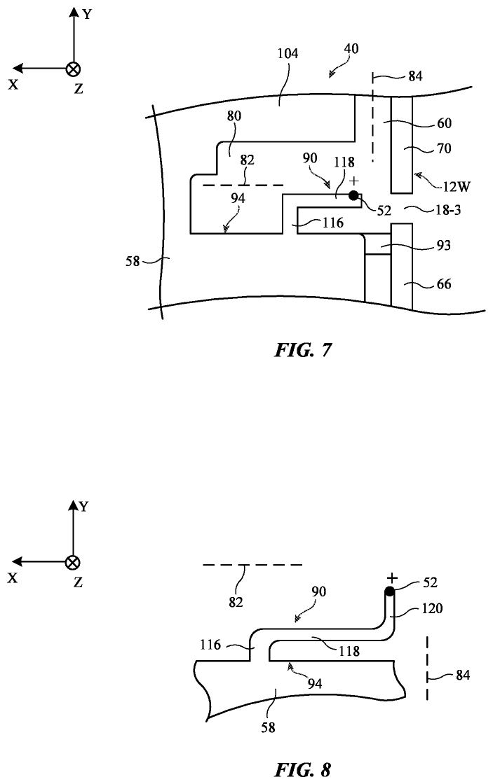

The example of FIG. 5 in which feed protrusion 90 has a straight (linear) shape is merely illustrative. If desired, feed protrusion 90 may include one or more bends within slot 80. FIG. 7 is a rear interior view of antenna 40 showing one example of how feed protrusion 90 may include one or more bends within slot 80.

As shown in FIG. 7, feed protrusion 90 may have a first segment 116 that extends from edge 94 parallel to longitudinal axis 84. Feed protrusion 90 may have a second segment 118 that extends from an end of segment 116 parallel to longitudinal axis 82 (e.g., perpendicular to segment 116 or at any other desired non-parallel angle relative to segment 116). Positive antenna feed terminal 52 may be coupled to the end of segment 118 opposite segment 116. In this way, feed protrusion 90 may be an L-shaped feed protrusion.

In the example of FIG. 7, conductive interconnect structure 93 is aligned with edge 94 to short antenna currents along edge 94 to segment 66 (e.g., without slot portion 78 protruding beyond edge 94 as shown in FIG. 5). This is merely illustrative and, if desired, conductive interconnect structure 93 may be laterally offset from edge 94 to allow slot portion 78 to protrude laterally downward beyond edge 94 (e.g., as shown in FIG. 5).

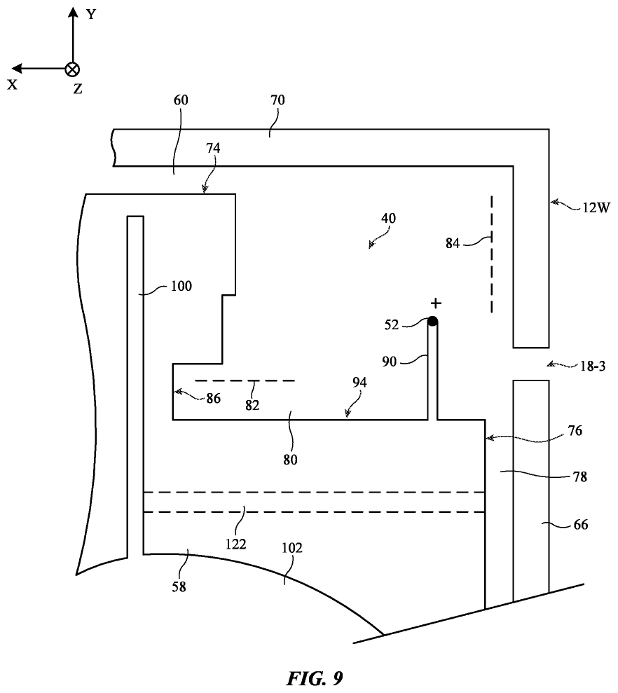

The example of FIG. 7 in which feed protrusion 90 is an L-shaped feed protrusion is merely illustrative. If desired, feed protrusion 90 may follow a meandering path. For example, as shown in FIG. 8, feed protrusion 90 may include at least a third segment 120 extending from the end of segment 118 opposite segment 116. Segment 120 may extend parallel to longitudinal axis 84 (e.g., perpendicular to segment 118 and/or parallel to segment 116) or at any other desired non-parallel angle with respect to segment 118. Positive antenna feed terminal 52 may be coupled to the end of segment 120 opposite segment 118. Feed protrusion 90 may include additional meandering segments if desired. Feed protrusion 90 may be continuously or gradually curved if desired. Adjusting the shape of the feed protrusion may be used to perform impedance matching for the antenna and/or to allow the antenna to be coupled to the overlapping printed circuit 110 (FIG. 6) for feeding given the other components that may be present within device 10.

The example of FIG. 5 in which segment 104 of conductive support plate 58 is laterally interposed between slot 80 and slot 60 is merely illustrative. If desired, segment 104 may be omitted, as shown in the example of FIG. 9. As shown in FIG. 9, this may configure antenna 40 to have an expanded slot antenna resonating element that includes slot 80, slot portion 78, and/or other portions of slot 60 between segment 70 and conductive support plate 58. Feed protrusion 90 may be linear (as shown in FIG. 9) or may be non-linear (e.g., provided with the shapes shown in FIG. 7 or 8).

If desired, the electromagnetic isolation of antenna 40 with respect to other device components may be further improved by providing conductive support plate with an additional electromagnetic isolation slot such as slot 122 between slot 80 and coil slot 102. Slot 122 may, for example, extend from slot 100 to slot portion 78 (e.g., may be interposed between edge 94 and coil slot 102). Slot 122 may extend parallel to longitudinal axis 82 or at other angles. Slot 122 may be provided in conductive support plate 58 in any of the examples of FIGS. 5-8. Similarly, tuning component 91 (FIG. 5) may be coupled to segment 66 in any of the examples of FIGS. 5-8. The antenna structures of FIGS. 5-8 may be combined in any desired manner. Slot 80 and antenna 40 need not be formed in the upper end of device 10 and may, if desired, be located at the lower end of device 10 or elsewhere in device 10.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made by those skilled in the art without departing from the scope and spirit of the described embodiments. The foregoing embodiments may be implemented individually or in any combination.

What is claimed is:

1. An electronic device comprising:
peripheral conductive housing structures having a dielectric-filled gap that divides the peripheral conductive housing structures into a first segment and a second segment, the first segment having a bend at a corner of the electronic device;
a display mounted to the peripheral conductive housing structures;
a dielectric cover layer mounted to the peripheral conductive housing structures opposite the display;
a conductive support plate that extends along the dielectric cover layer opposite the display;
a first slot that separates the conductive support plate from the first segment and the second segment;
a second slot that extends into the conductive support plate from the first slot; and
an antenna configured to convey radio-frequency signals through the dielectric cover layer, wherein the antenna has a positive feed terminal coupled to an edge of the second slot and the antenna has a slot antenna resonating element that includes the first slot and the second slot.

2. The electronic device of claim 1, wherein the first slot extends along a first longitudinal axis and the second slot extends along a second longitudinal axis that is non-parallel with respect to the first longitudinal axis.

3. The electronic device of claim 2, wherein the second longitudinal axis is perpendicular to the first longitudinal axis.

4. The electronic device of claim 1, wherein the conductive support plate has a feed protrusion that extends into the second slot, the positive antenna feed terminal being coupled to the feed protrusion.

5. The electronic device of claim 4, wherein the feed protrusion has a linear shape.

6. The electronic device of claim 4, wherein the feed protrusion has a first portion extending from the edge of the conductive support plate and has a second portion extending perpendicularly from an end of the first portion.

7. The electronic device of claim 6, wherein the positive antenna feed terminal is coupled to an end of the second portion.

8. The electronic device of claim 6, wherein the feed protrusion has a third portion extending perpendicularly from an end of the second portion, the positive antenna feed terminal being coupled to an end of the third portion.

9. The electronic device of claim 1, further comprising:
a conductive interconnect that couples the conductive support plate to the second segment, wherein the first slot laterally extends beyond the edge to the conductive interconnect.

10. The electronic device of claim 1, further comprising:
an opening in the conductive support plate;
a camera configured to capture images through the opening; and
an electromagnetic isolation slot in the conductive support plate and laterally interposed between the second slot and the opening.

11. The electronic device of claim 10, further comprising:
an additional electromagnetic isolation slot in the conductive support plate that extends from the electromagnetic isolation slot to the first slot.

12. The electronic device of claim 1, further comprising:
a tuning component coupled to the first segment at the dielectric-filled gap.

13. The electronic device of claim 1, wherein the peripheral conductive housing structures have an additional dielectric-filled gap that separates the first segment from a third segment of the peripheral conductive housing structures, the third segment and the additional dielectric segment are at a first side of the bend, the dielectric-filled gap and the second segment are at a second side of the bend, and the conductive support plate has a segment that is laterally interposed between the second slot and a portion of the first segment at the first side of the bend.

14. An electronic device comprising:
a housing having peripheral conductive housing structures and a dielectric cover layer mounted to the peripheral conductive housing structures;
a display mounted to the peripheral conductive housing structures opposite the dielectric cover layer;
a conductive support plate overlapping the dielectric cover layer opposite the display; and
an antenna having a radiating slot configured to convey radio-frequency signals through the dielectric cover layer, wherein
the radiating slot has a first segment that is laterally interposed between the conductive support plate and the peripheral conductive housing structures and that extends along a first longitudinal axis,
the radiating slot has a second segment that extends from the first segment into the conductive support plate along a second longitudinal axis orthogonal to the first longitudinal axis, and
the radiating slot is fed at an antenna feed terminal coupled to an edge of the second segment.

15. The electronic device of claim 14, wherein the conductive support plate comprises a feed protrusion that extends from the edge of the second segment of the radiating slot into the second segment of the radiating slot, the antenna feed terminal being coupled to an end of the feed protrusion.

16. The electronic device of claim 15, wherein the feed protrusion and the conductive support plate are formed from integral portions of a single piece of sheet metal.

17. The electronic device of claim 15, further comprising:
a flexible printed circuit that extends along the conductive support plate;
a radio-frequency transmission line having a signal trace on the flexible printed circuit; and
a conductive interconnect that couples the signal trace to the feed protrusion at the antenna feed terminal.

18. The electronic device of claim 17, wherein the conductive interconnect comprises a conductive spring.

19. An electronic device comprising:
peripheral conductive housing structures;
a display mounted to the peripheral conductive housing structures;
a rear housing wall mounted to the peripheral conductive housing structures opposite the display, the rear housing wall having a dielectric cover layer and a conductive support plate that extends along the dielectric cover layer; and
an antenna having a slot antenna resonating element configured to radiate through the dielectric cover layer, wherein the slot antenna resonating element includes a slot in the conductive support plate, the conductive support plate has an integral protrusion that extends into the slot, and the antenna is fed by a positive antenna feed terminal coupled to the integral protrusion of the conductive support plate.

20. The electronic device of claim 19, wherein the slot antenna resonating element includes an additional slot between the conductive support plate and the peripheral conductive housing structures, the additional slot extends along a first longitudinal axis, and the slot extends from the additional slot along a second longitudinal axis perpendicular to the first longitudinal axis.
